(19) United States
(12) Patent Application Publication
(10) Pub. No.: US 2010/0053031 A1
(43) Pub. Date: Mar. 4, 2010

(54) ELECTRO-OPTICAL DEVICE AND ELECTRONIC APPARATUS

(75) Inventor: Satofumi KOIKE, Isehara-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: SEIKO EPSON CORPORATION, Tokyo (JP)

(21) Appl. No.: 12/537,330

(22) Filed: Aug. 7, 2009

(30) Foreign Application Priority Data
Aug. 28, 2008 (JP) 2008-219269

(51) Int. Cl. G09G 5/00

(52) U.S. Cl. 345/8

(57) ABSTRACT

An electro-optical device, in which the position of the view point of a viewer who sees the display region on a substrate is fixed to a predetermined position within the display region in a plan view, includes a first color filter which overlaps a first pixel region disposed at the predetermined position among a plurality of pixel regions constituting the display region and a second color filter which overlaps a second pixel region disposed closer to an outer side of the display region than the predetermined position among the plurality of pixel regions, in which the hue of the first color filter is the same as that of the second color filter, and thicknesses of the first and second color filters are set such that a difference in density of color between a first display ray which has passed through the first color filter and a second display ray which has passed through the second color filter is small when measuring the first display ray and the second display ray at the position of the view point.

### BACKGROUND

1. Technical Field

The present invention relates to a technique of an electro-optical device which can perform a color display and a technique of an electronic apparatus equipped with such an electro-optical device, such as a head mounted display (hereinafter, referred to as HMD) or an electronic viewfinder (hereinafter, referred to as EVF).

2. Related Art

In a liquid crystal device which is an example of such an electro-optical device, a color image is displayed by three kinds of colored rays, a red ray(R), a green ray(G), and a blue ray(B) which have passed through plural kinds of color filters. JU-A-H6-55137 discloses a liquid crystal display device capable of reducing the occurrence of color mixture attributable to the thickness of the glass substrate on which the color filters are provided. JP-A-H11-38426 and JP-A-2005-257758 disclose display devices capable of inhibiting a lowering of the aperture ratio which can occur according to the positions of view points from which a display region is viewed and suppressing the distortion of the displayed image.

In such a kind of electro-optical devices, the relative position of the view point with respect to the display region is nearly fixed. In the case in which color filters are formed in uniform thickness over the entire display region, at the time when a first ray, which has passed through the color filter provided at an overlapping position of the display region at which the view point is overlapped in a plan view (for example, the center portion of the display region), and a second ray, which has passed through the color filter provided at a position which is closer to the outer side of the display region than the overlapping position where the color filter overlaps the view point in the plan view, reach the view point, optical path lengths of these rays in the color filters are different from each other. Accordingly, even when performing a display in which the brightness and density of color between the first ray and the second ray must be identical, a phenomenon occurs whereby the brightness and color density of the first ray become different from the brightness and color density of the second ray.

In more detail, the first ray which has passed through the color filter disposed at the overlapping position with the view point in a plan view (for example, the center portion of the display region) and reached the view point is a ray which has entered and passed through the color filter in a thickness direction of the color filter, but the second ray which has passed through the color filter disposed at the position closer to the outer side of the display region than the overlapping position with the view point in the plan view and reached the view point is a ray which has diagonally entered and passed through the color filter with respect to the thickness direction of the color filter.

Accordingly, even though the color filter is formed in the uniform thickness over the entire area of the display region, the optical path length in the color filter of the first ray is different from the optical path length in the color filter of the second ray. For this reason, there is unevenness in the brightness of an image displayed in the display region, or the hue of the image displayed in the display region becomes different from the hue which is supposed to be originally displayed.

In particular, in the electro-optical devices, such as a liquid crystal display device, which are mounted in electronic apparatuses, such as an HDM or an EVF, in which the position of the view point with respect to the display region at which the image is displayed is fixed in a plan view and which are used under a condition that the view point is close to the display surface, serious problems can arise since the angle between the display surface and a line of sight extending from the view point to a certain pixel region within the display region significantly changes according to the position of the pixel region.

### SUMMARY

It is an object of the invention to provide an electro-optical device, such as a liquid crystal display device, which can display an image which is uniform in brightness and has the hue which is supposed to be originally displayed, and an electronic apparatus including the electro-optical device.

There is provided an electro-optical device, in which a position of a view point of a viewer is fixed to a predetermined position within a display region in a plan view, including a first color filter which overlaps a first pixel region disposed at the predetermined position among a plurality of pixel regions constituting the display region, and a second color filter which overlaps a second pixel region disposed closer to an outer side of the display region than the predetermined position among the plurality of pixel regions, in which the hue of the first color filter is the same as that of the second color filter, and thicknesses of the first and second color filters are set such that a difference in density of color between a first display ray which has passed through the first color filter and a second display ray which has passed through the second color filter is small when measuring the first display ray and the second display ray at the position of the view point.

According to the electro-optical device, the electro-optical device is used under a condition that the position of the view point of a viewer is fixed to the predetermined position within the display region in a plan view, which is, for example, the center portion of the display region, and the electro-optical device displays an image at the display region.

In the electro-optical device, the first color filter overlaps the first pixel region among the plurality of pixel regions constituting the display region, the first pixel region being formed at the predetermined position, and transmits a colored ray of light modulated in the first pixel region, which can pass through the first color filter, as the first display ray.

In the electro-optical device, the second color filter overlaps the second pixel region among the plurality of the pixel regions, which is formed closer to the outer side of the display region when it is viewed from the predetermined position, and transmits a colored ray of the light modulated in the second pixel region, which can pass through the second color filter, as the second display ray.

In the electro-optical device, it is preferable that the hue of the first color filter and the hue of the second color filter are identical, and that the thicknesses of the first and second color filters are set such that, when measuring the first display ray which has passed through the first color filter and the second display ray which has passed through the second color filter, at the view point, the difference in density of color between the first and second display rays is small. In greater detail, the thicknesses of the first and second color filters are set such that the optical path length of the first display ray in the first color filter is almost the same as the optical path length of the second display ray in the second color filter.

Accordingly, according to the electro-optical device of the invention, since it is possible to reduce the brightness difference and the color density difference attributable to the difference between the optical path lengths of the first and second display rays, it is possible to reduce unevenness in the brightness of an image displayed at the display region and suppress the occurrence of an event in which the hue of the image displayed in the display region becomes different from the hue which is supposed to be originally displayed. As a result, it is possible to improve the display performance of the electro-optical device.

In the electro-optical device according to one aspect of the invention, it is preferable that the thickness of the second color filter is smaller than that of the first color filter.

According to such an aspect, it is possible to make the optical path lengths equal when the first and second display rays pass through the first and second color filters respectively as compared with the case in which the thicknesses of the first and second color filters are almost the same as each other. In order to adjust the thicknesses of the first and second color filters, for example, a chemical mechanical polishing method (CMP method) or a spin coat method may be used under appropriate conditions in the manufacturing process of the electro-optical device.

According to another aspect of the invention, there is provided an electronic apparatus including the electro-optical device.

According to the electronic apparatus, for example, since the electronic apparatus is used in a state in which the position of the view point is fixed in the display region at which the image is displayed in a plan view, and the view point is close to the display surface, it is possible to display an image with uniform brightness and with the original hue as it is supposed to be displayed in the HMD or the EVF with large differences between the angles of the lines of sight extending from portions of the display region to the view point with respect to the display surface.

Operation and other advantages of the invention will be described with reference to the below-described embodiments.

### BRIEF DESCRIPTION OF THE DRAWINGS

The invention will be described with reference to the accompanying drawings, wherein like numbers reference like elements.

FIG. 1 is a front view illustrating a state in which an HMD according to one embodiment is mounted on a head portion.

FIG. 2 is a side view illustrating a state in which the HMD according to the embodiment is mounted on the head portion.

FIG. 3 is a plan view illustrating a liquid crystal device according to one embodiment of the invention.

FIG. 4 is a sectional view taken along line IV-IV of FIG. 3.

FIG. 5 is an equivalent circuit diagram illustrating various kinds of elements and wirings existing in a plurality of pixel regions which are formed in a matrix form and constitute an image display region of the liquid crystal device according to the embodiment.

FIG. 6 is a partial sectional view illustrating the image display region of the liquid crystal device according to the embodiment.

FIG. 7 is a schematic view schematically illustrating the relative positional relationship between the liquid crystal device according to the embodiment and the view point of a viewer who sees an image displayed in the image display region 10a of the liquid crystal device.

FIGS. 8A and 8B are schematic views schematically illustrating a relationship between the display rays which pass through portions of the liquid crystal device according to the embodiment and the thicknesses of color filters.

### DESCRIPTION OF EXEMPLARY EMBODIMENTS

Hereinafter, embodiments of an electro-optical device and an electronic apparatus according to the invention will be described with reference to the accompanying drawings.

### 1. Electronic Apparatus

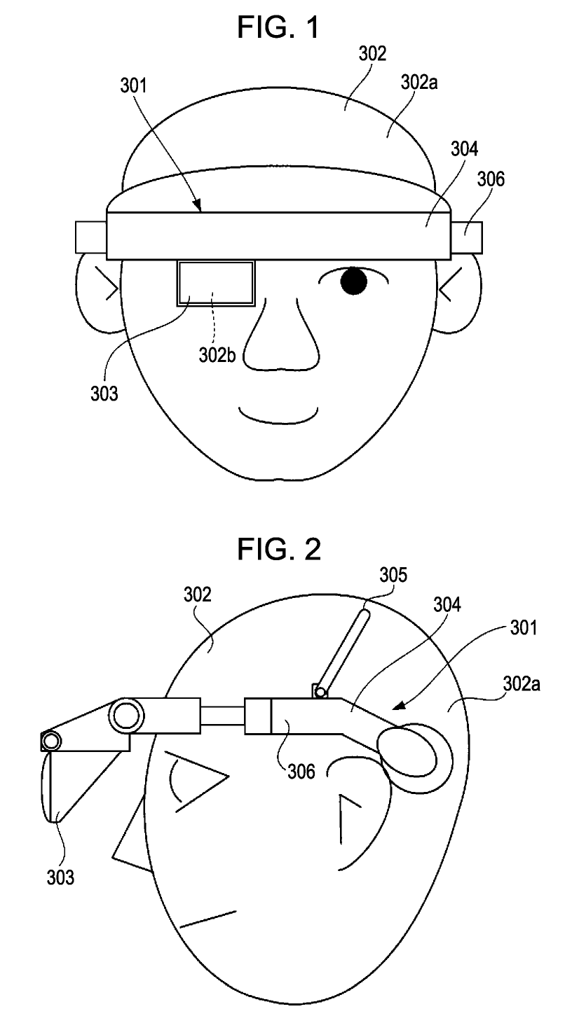

First, an HMD which is an example of an electronic apparatus according to the invention will be described with reference to FIGS. 1 and 2. FIG. 1 is a front view illustrating a state in which the HMD according to one embodiment is mounted on a head portion. FIG. 2 is a side view illustrating a state in which the HMD according to the embodiment is mounted on the head portion.

As shown in FIGS. 1 and 2, the HMD 301 is used in a state in which the HMD 301 is mounted on a head portion 302a of a viewer 302 who sees an image displayed by the HMD 301. The HMD 301 has a display portion 303 positioned in front of a right eye 302b of the viewer 302. The HMD 301 displays an image at an image display region of the display portion 303 at the time of operation. The viewer 302 sees an image displayed at the image display region of the display portion 303 at the time of operation of the HMD 301. According to the image displayed at the image display region of the display portion 303, the viewer 302 can feel as if he or she sees an image displayed on a 100 inch-size screen.

The HMD 301 includes a mounting portion 304 which allows the display portion 303 to be mounted on the head portion 302a of the viewer 302. The mounting portion 304 includes a U-shaped holding portion 305 extending along the head portion 302a and a frame 306 extending in a manner such that it can be hung on both ears of the viewer. Thanks to the holding portion 305 and the frame 306, the HMD 301 is fixed to the head portion 302a of the viewer 302. Accordingly, when using the HMD 301, the relative position between the display portion 303 and the view point, i.e. the right eye 302b, at which the image displayed at the image display region of the display portion 303 is recognized, is fixed. Accordingly, there is possibility that the image displayed at the image display region of the display portion 303 and the image recognized by the right eye 302b are different from each other due to the difference in the optical path lengths of display rays which occurs when the display rays emitted toward the right eye 302b from an overlapping position which overlaps with the view point in a plan view (i.e. the position corresponding to the right eye 302b in a plan view) of the display portion 303 and the display rays emitted toward the right eye 302b from a region closer to the outer side of the image display region of the display portion 303 than the overlapping position pass through color filters within the display portion 303.

In particular, in the case of the HMD 301 used in the state of being mounted on the head portion 302a of the viewer 302, the distance between the display portion 303 and the right eye 302b, which is the view point at which the image is recognized, is relatively short when compared to a projector or a display device, such as a large-size display device, by which the viewer can recognize the image positioned separate from the viewer. In greater detail, for example, the distance between the display portion 303 and the right eye 302b which is the view point at which the image is recognized becomes several centimeters. Accordingly, it is recognized by the right eye 302b such that the display rays emitted from portions of the image display region of the display portion 303 seem to be emitted from color filters having different thicknesses. In greater detail, since optical paths are not parallel with each other when the display rays pass through the color filters, even though the display rays pass through the corresponding color filters having the same hue and thickness, the optical path lengths in the color filters are different from each other. Since the optical path lengths in the respective color filters are different from each other, even in the case of performing the display in which the display rays must be identical in the brightness and the density of color, an event occurs such that the display rays recognized by the right eye 302b, which is the view point, are different from each other in the brightness and the density of color.

However, according to the HMD 301 of this embodiment, since the liquid crystal device 1, the detail of which will be described later, is used as the display portion 303, it is possible to reduce the differences in the brightness and density of color between the display rays emitted from respective portions of the image display region of the display portion 303. Accordingly, the viewer 302 can recognize the image displayed on the HMD 301 with even brightness and with the original hue as it is supposed to be displayed.

In addition, in this embodiment, the HMD is exemplified as one embodiment of the electronic apparatus according to the invention. However, other kinds of electronic apparatuses used in a state in which the position of the view point of the viewer is fixed within the image display region at which the image is displayed in a plan view may be within the concept of the electronic apparatus of the invention. In greater detail, electronic apparatuses such as EVF are also included in the concept of the electronic apparatus of the invention.

### 2. Electro-Optical Device

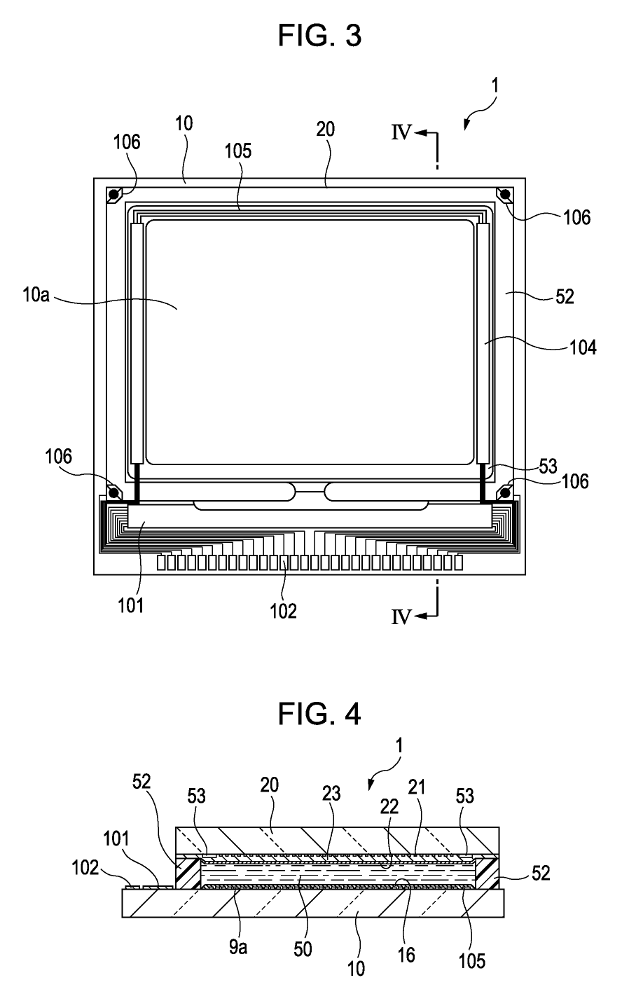

Next, the liquid crystal device 1 which is an embodiment of the electro-optical device of the invention will be described with reference to FIGS. 3 to 8.

### 2-1. Overall Structure of Electro-Optical Device

FIG. 3 is a plan view illustrating a liquid crystal device according to the embodiment and FIG. 4 is a sectional view taken along line IV-IV of FIG. 3. In this embodiment, a drive circuit incorporated TFT active matrix drive type liquid crystal device 1 is disclosed as an example of an electro-optical device.

In FIGS. 3 and 4, in the liquid crystal device 1, a TFT array substrate 10 and an opposing substrate 20 are placed to face each other. A liquid crystal layer 50 is sealed between the TFT array substrate 10 and the opposing substrate 20. The TFT array substrate 10 and the opposing substrate 20 are bonded to each other by a sealing member 52 provided at a sealing region disposed at the peripherals of an image display region 10a, which is a typical example of the “display region” of the invention. The image display region 10a is composed of a plurality of pixel regions, each of which is provided with a pixel portion.

The sealing member 52 is made of, for example, a ultraviolet ray (UV ray) curable resin or a thermosetting resin for bonding the TFT array substrate 10 and the opposing substrate 20 to each other. In the manufacturing process, the resin for the sealing member is coated on the TFT array substrate 10, and is then cured by UV ray radiation or heat. Gap members, such as glass fiber or glass beads, are distributed in the sealing member 52 to maintain the distance (inter-substrate gap) between the TFT array substrate 10 and the opposing substrate 20 at a predetermined value.

A frame light shielding film 53, having a light shielding characteristic and defining a frame region of the image display region 10a, is provided inside the sealing region, at which the sealing member 52 is provided, which runs in parallel with the sealing member 52 at the opposing substrate 20 side. A portion or all of the frame light shielding film 53 may be disposed at the side of the TFT array substrate 10 as an embedded light shielding film. There is a peripheral region positioned at the peripherals of the image display region 10a. In other words, in this embodiment, an area farther from the center portion of the TFT array substrate 10 than the frame light shielding film 53 is defined as the peripheral region.

At a portion of the peripheral region which is placed outside the sealing region at which the sealing member 52 is provided, a data line drive circuit 101 and external circuit connection terminals 102 are provided along one edge of the TFT array substrate 10. A scan line drive circuit 104 is provided along two edges of the TFT array substrate 10 which are adjacent to the edge along which the data line drive circuit is provided in a manner of covering the frame light shielding film 53. In addition, a plurality of wirings 105 is provided along the other edge of the TFT array substrate 10 to connect the two parts of the scan line drive circuit 104 which are provided at both sides of the image display region 10a in such a manner to each other so as to cover the frame light shielding film 53.

Vertical conduction members 106, serving as vertical conduction terminals, are placed at four corners of the opposing substrate 20. On the other hand, the TFT array substrate 10 is provided with vertical conduction terminals at areas facing the corners. With such a structure, the TFT array substrate 10 and the opposing substrate 20 can be electrically connected.

In FIG. 2, on the TFT array substrate 10, an aligning film 16 is formed on a plurality of pixel electrodes 9a which is formed after TFTs serving as pixel switching elements and wirings such as scan lines and data lines are formed. The pixel electrodes 9a are made of a transparent conductive film, for example, an indium tin oxide (ITO) film. The aligning film 16 is an organic film, such as a polyimide film, or an inorganic aligning film formed by an oblique deposition method. The TFT array substrate 10 is a transparent substrate, for example, a quartz substrate or a glass substrate, or a semiconductor substrate, such as a silicon substrate.

On the other hand, on the opposing substrate 20, an opposing electrode 21 and a light shielding film 23 having a matrix form or a stripe form are formed. Further, the aligning film 22 is formed at a top layer portion. The opposing substrate 20 is a transparent substrate like the TFT array substrate 10. The liquid crystal layer 50 is composed of one kind of nematic liquid crystals or is composed of a mixture of several kinds of nematic liquid crystals. The liquid crystal layer takes a predetermined alignment state between a pair of aligning films.

The opposing substrate 20 is provided with the opposing electrode 21 over its entire surface thereof and an aligning film 22 is provided under the opposing electrode 21. The opposing electrode 21 is made of a transparent conductive film, such as the ITO film. The aligning film 22 is formed from the same material and film forming method as the aligning film 16.

Further, on the TFT array substrate 10 shown in FIGS. 1 and 2, in addition to drive circuits, such as the data line drive circuit 101 and the scan line drive circuit 104, a sampling circuit for sampling an image signal on an image signal line and supplying the image signal to data lines, a pre-charge circuit for supplying a pre-charge signal having a predetermined voltage level to the plurality of data lines before the image signal, and a test circuit for testing quality and defect of the electro-optical device at the time of manufacturing or shipping are formed.

### 2-2. Electrical Connection Structure of Pixel Portion

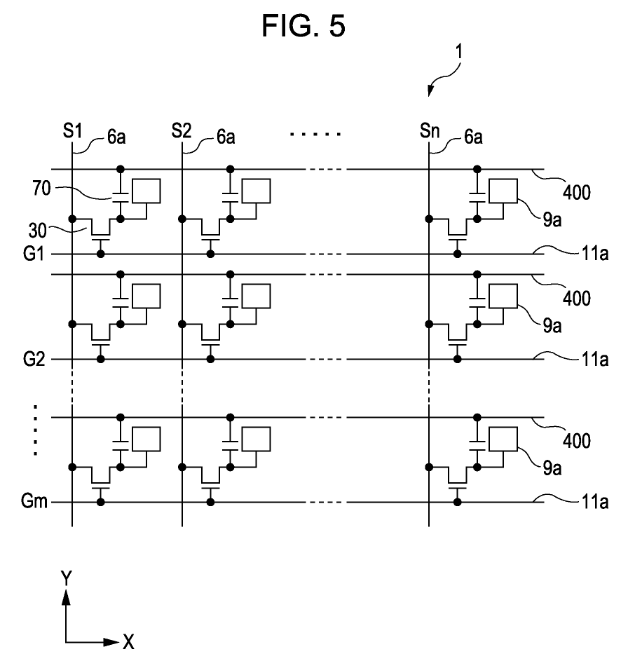

Next, the electrical connection structure in the pixel region of the liquid crystal device 1 will be described in detail with reference to FIG. 5. FIG. 5 is an equivalent circuit diagram showing various kinds of elements and wirings which constitute the image display region 10a of the liquid crystal device 1 and are formed in a plurality of pixel regions arranged in a matrix form.

In FIG. 5, each of the plurality of pixel regions which constitutes the image display region 10a of the liquid crystal device 1 and is arranged in a matrix form is provided with a pixel electrode 9a and a TFT 30. The TFT 30 is electrically connected to the pixel electrode 9a and functions as so to switch the pixel electrode 9a at the time of operation of the liquid crystal device 1. The data lines 6a to which the image signals are supplied to are electrically connected to sources of the TFTs 30. The image signals S1, S2, . . . , and Sn which are to be written into the data lines 6a may be sequentially supplied to the data lines 6a in this order or supplied to the data lines 6a group by group in which the data lines 6a are adjacent to each other in each group.

Gates of the TFTs 30 are electrically connected to the scan lines 11a. The liquid crystal device 1 is structured so as to sequentially supply scan signals G1, G2, . . . , and Gm to the scan lines 11a in this order in a pulse form at predetermined timing. The pixel electrodes 9a are electrically connected to the drains of the TFTs 30 and the image signals S1, S2, . . . , and Sn supplied from the data lines 6a are written at predetermined timing as the TFTs 30 serving as the switching elements are closed for a predetermined time. The image signals S1, S2, . . . , and Sn, having a predetermined level and written into the liquid crystal via the pixel electrodes 9a, are sustained between the opposing electrode 21 formed on the opposing substrate 20 and the pixel electrodes for a predetermined time.

Molecular alignment and order of the liquid crystal contained in the liquid crystal layer 50 changes according to a voltage level which is applied. Therefore, light is modulated and a gradation display can be attained. In a normally white mode, the transmittance with respect to incident light is decreased according to a voltage applied pixel by pixel. In a normally black mode, the transmittance with respect to the incident light is increased according to the voltage applied pixel by pixel. As a result, light, having contrast depending on the image signal, is emitted from the liquid crystal device as a whole. In order to prevent the image signals which are sustained from leaking, storage capacitors 70 are provided in parallel with liquid crystal capacitors formed between the pixel electrodes 9a and the opposing electrode 21. One capacitor electrode of the storage capacitor 70 is electrically connected to a fixed potential line 400 which is fixed to a potential and the other capacitor electrode is electrically connected to a drain of the TFT 30. With such a structure, the potential sustaining characteristic in the pixel electrode 9a is improved, and the display characteristics, for example contrast and flickering, can also be improved.

### 2-3. Detailed Structure of Electro-Optical Device

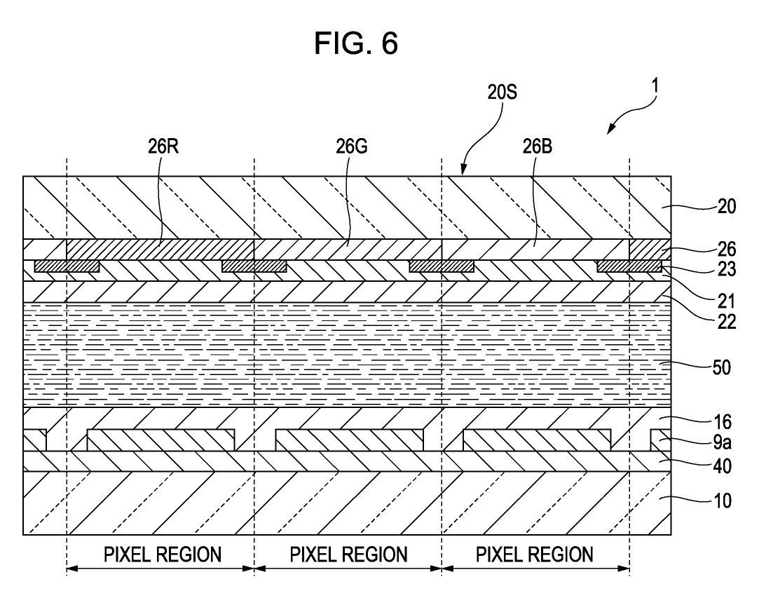

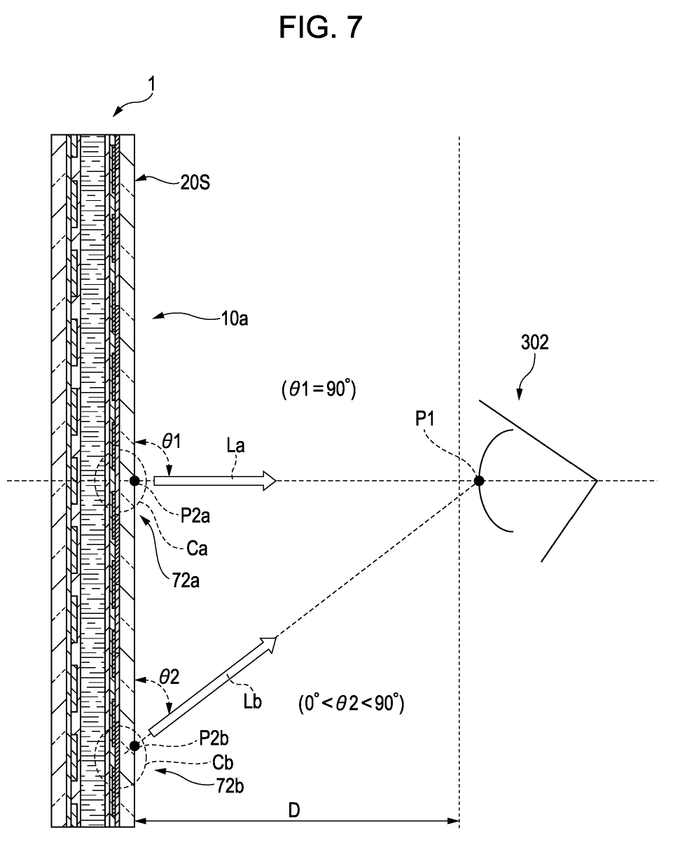

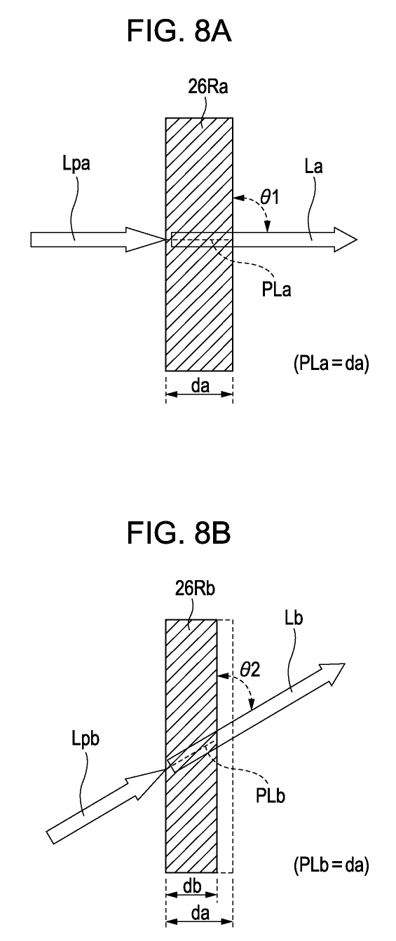

The detailed structure of the liquid crystal device 1 according to this embodiment will be described with reference to FIGS. 6 to 8. FIG. 6 is a partial sectional view illustrating an image display region 10a of the liquid crystal device 1 according to this embodiment. FIG. 7 is a schematic view schematically showing a relative positional relationship between the liquid crystal device according to this embodiment and the view point of a viewer who sees an image displayed at the image display region 10a of the liquid crystal device. FIG. 8 is a schematic view schematically showing a relationship between a display ray which passes through respective portions of the liquid crystal device according to this embodiment and the thickness of the color filter.

In FIG. 6, in the liquid crystal device 1, the pixel electrodes 9a are formed at respective pixel regions using a base film 40 formed on the TFT array substrate 10 as a base. The liquid crystal device 1 has three kinds of color filters 26R, 26G, and 26B provided so as to correspond to respective pixel regions at the opposing substrate 20 side. When the liquid crystal device 1 is driven, the color filters 26R, 26G, and 26B respectively transmit red rays, green rays, and blue rays as part of colored rays of light modulated in the liquid crystal layer 50 toward the opposing substrate 20 as display rays. Each of the display rays is emitted from the display surface 20S and therefore a color image is displayed at the image display region 10a.

In FIG. 7, in the liquid crystal device 1, the position of the view point P1 of the viewer 302 who sees the image display region 10a is fixed to a predetermined position P2a within the image display region 10a in a plan view, for example, the center portion of the image display region 10a, at the time of use.

In a first pixel region 72a formed at a predetermined position P2a among a plurality of pixel regions which constitutes the image display region 10a, modulated light Lpa (see FIG. 8A) modulated by a portion of the liquid crystal layer provided at the first pixel region 72a passes through a color filter of a red color which overlaps the first pixel region 72a and is emitted toward the view point P1 from the display surface 20S as the first display ray La. In the color filter, the angle θ1 between the optical path of the first display ray La and the display surface 20S, i.e. the surface of the color filter provided at the first pixel region 72a, is 90°.

On the other hand, in a second pixel region 72b among the plurality of pixel regions, which is provided at the position P2b closer to the outer side of the image display region 10a than the predetermined position P2a, modulated light Lpb (see FIG. 8B) modulated by a portion of the liquid crystal layer provided at the second pixel region 72b passes through the color filter of a red color which overlaps the second pixel region 72b and is emitted toward the view point P1 from the display surface 20S as the second display ray Lb. The angle θ2 between the optical path of the second display ray Lb in the color filter and the surface of the color filter provided at the display surface 20S, i.e. the second pixel region 72b, is larger than 0° but smaller than 90°.

If the thicknesses of the color filter provided at the first pixel region 72a and the color filter provided at the second pixel region 72b are equal to each other, an optical path length of the second display ray Lb in the color filter disposed at the second pixel region 72b becomes larger than an optical path length when the first display ray La passes through the color filter provided at the first display region 72a. Accordingly, when recognizing the first display ray La and the second display ray Lb at the view point P1, respectively, there is a difference in brightness and the difference in density of color between the first display ray La and the second display ray Lb. In particular, as the distance D between the display surface 20S and the view point P1 becomes smaller, the difference becomes larger. Further, there is unevenness in the brightness in the image displayed at the image display region 10a, or there can be a problem whereby the hue of the image displayed at the image display region 10a is different from the hue originally supposed to be displayed.

A relationship between thicknesses of the color filters at regions Ca and Cb shown in FIG. 7 will be described with reference to FIG. 8.

As shown in FIG. 8A, the liquid crystal device 1 has a color filter 26Ra of a red color which is provided at the first pixel region 72a (see FIG. 7). The color filter 26Ra is an example of a “first color filter” of the invention. As shown in FIG. 8B, the liquid crystal device 1 has a color filter 26Rb of a red color which is provided at the second pixel region 72b (see FIG. 7). The color filter 26Rb is an example of a “second color filter” of the invention.

As shown in FIGS. 8A and 8B, in the liquid crystal device 1, thicknesses da and db of the color filters 26Ra and 26Rb are set such that both of the differences in brightness and in density of color between the first display ray La observed at the view point P1 and the second display ray Lb observed at the view point P1 are small. In greater detail, the thickness db of the color filter 26Rb is set to be smaller than the thickness da of the color filter 26Ra.

Accordingly, with such a structure of the liquid crystal device 1, it is possible to equalize the optical path length PLb of the second display ray Lb in the color filter 26Rb with the optical path length PLa of the first display ray La in the color filter 26Ra as compared with the case in which thicknesses da and db of the color filters 26Ra and 26Rb are set to be equal. Accordingly, with such a structure of the liquid crystal device 1 according to this embodiment, since it is possible to reduce the difference in brightness and the difference in density of color which are created due to the difference in the optical path length between the first and second display rays La and Lb, it is possible to inhibit an event in which there is unevenness in the brightness of an image displayed at the image display region 10a and an event in which the hue of the image displayed at the image display region 10a is different from the hue of the image which is originally supposed to be displayed, and it is also possible to improve the display performance of the liquid crystal device 1.

In this embodiment, the position of the view point P1 of the viewer 302 who sees the image display region 10a is fixed to the center portion of the image display region 10a in a plan view. However, the position of the view point P1 may not be limited to the center portion of the image display region 10a. Further, although the angle θ1 is set to 90° in this embodiment, the angle θ1 is not limited to be 90°.

In order to adjust the thicknesses of the color filters 26Ra and 26Rb, for example, the surface of the base film of the color filters is processed with a chemical mechanical polishing (CMP) method in the manufacturing process of the liquid crystal device 1 to get surface roughness. Alternatively, the thickness of the color filter may be adjusted using a spin coat method.

What is claimed is:

1. An electro-optical device in which a position of a view point of a viewer is fixed to a predetermined position within a display region in a plan view, comprising:
a first color filter which overlaps a first pixel region disposed at the predetermined position among a plurality of pixel regions constituting the display region; and
a second color filter which overlaps a second pixel region disposed closer to an outer side of the display region than the predetermined position among the plurality of pixel regions,
wherein a hue of the first color filter is the same as that of the second color filter, and thicknesses of the first and second color filters are set such that a difference in density of color between a first display ray which has passed through the first color filter and a second display ray which has passed through the second color filter is small when measuring the first display ray and the second display ray at the position of the view point.

2. The electro-optical device according to claim 1, wherein the thickness of the second color filter is smaller than that of the first color filter.

3. An electronic apparatus comprising the electro-optical device according to claim 1.
